(19) United States
(12) Patent Application Publication
(10) Pub. No.: US 2007/0232111 A1
(43) Pub. Date: Oct. 4, 2007

(54) Card edge connector

(75) Inventor: Chih-Ping Shao, Keelung City (TW)

Correspondence Address: TROXELL LAW OFFICE PLLC;SUITE 1404, 5205 LEESBURG PIKE, FALLS CHURCH, VA, 22041, US

(73) Assignee: Lotes Co., Ltd.

(21) Appl. No.: 11/393,812

(22) Filed: Mar. 31, 2006

(51) Int. Cl. H01R 13/62

(52) U.S. Cl. 439/327

(57) ABSTRACT

A card edge connector includes an insulating body having a central slot formed at a longitudinal direction thereof. A pair of locking devices is installed at both opposite distal ends of the insulator body and each locking device has a metal unit. The metal unit is formed by bending the first arm and the second arm upwards by the first arm. The second arm is placed outside the first arm and has a stop portion for limiting over-movement of the first arm. More space and material is saved because of its simple structure, convenient production, easy assembly and disassembly so as to enhance production efficiency.

### BACKGROUND OF THE INVENTION

(a) Field of the Invention

The present invention relates to connectors, and in particular to a card edge connector.

(b) Description of the Prior Art

In current connector industry, a card edge connector for connecting a memory module to a circuit board usually includes a longitudinal direction insulating body. The insulating body has a central slot for receiving the memory module. A plurality of conductive terminals are positioned on the two sides of the central long trench so as to connect electrically and mechanically the memory module. A pair of locking devices are installed two distal end of the oppositely sides of the insulating body. Each locking device has a plastic unit and a metal unit. The plastic unit is formed by extending forwards the two distal sides of the insulating body. The locking device serves to connect firmly the memory module to the card edge connector so as to complete the electrical connection between the memory module and the circuit board, such as those disclosed in China Patent No. CN00203324. However, this kind of prior arts card edge connector has several defects, such as complicating metal unit structure, costing more material, occupying more space and inconvenient for assembly and disassembly. Therefore, it is necessary to develop a new type of card edge connector for overcoming the above-mentioned faults.

### SUMMARY OF THE INVENTION

The primary objective of the present invention is to provide a card edge connector. The card edge connector has several advantages, such as simple structure thereof, convenient to assemble and disassemble thereof, downsizing thereof, reducing production cost, convenient to product and enhancing the production efficiency.

### BRIEF DESCRIPTION OF THE DRAWINGS

FIG. 1 is an assembled perspective view of the present invention.

FIG. 2 is an exploded perspective view of the present invention.

FIG. 3 is a partial enlarged view of the present invention.

FIG. 4 is a perspective view showing partial enlargement of the present invention.

FIG. 5 is an exploded perspective view of the second embodiment of the present invention.

FIG. 6 is a partial enlarged view of the second embodiment of the present invention.

FIG. 7 is a perspective view showing a partial enlargement of the second embodiment of the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

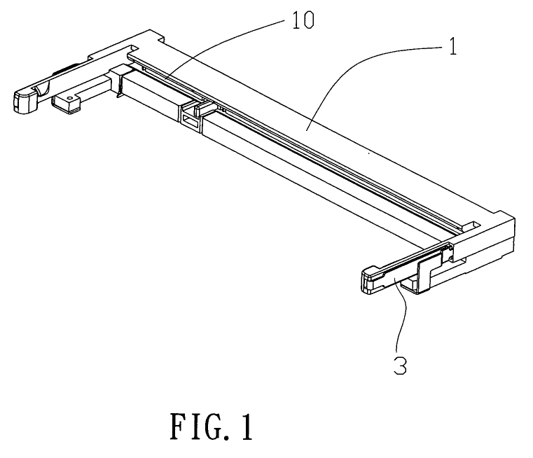

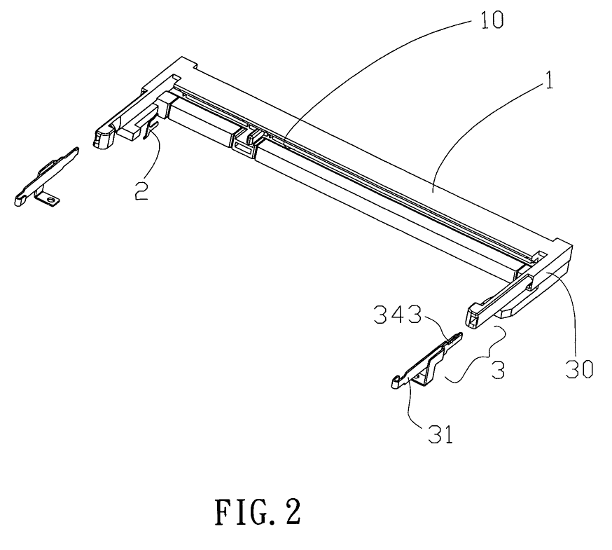

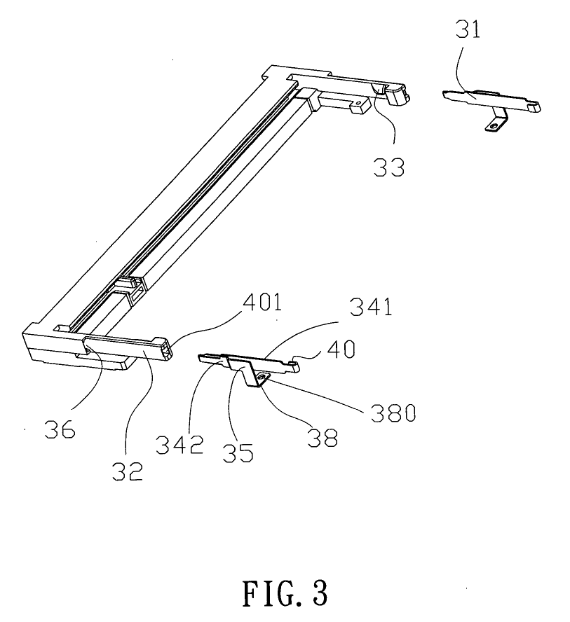

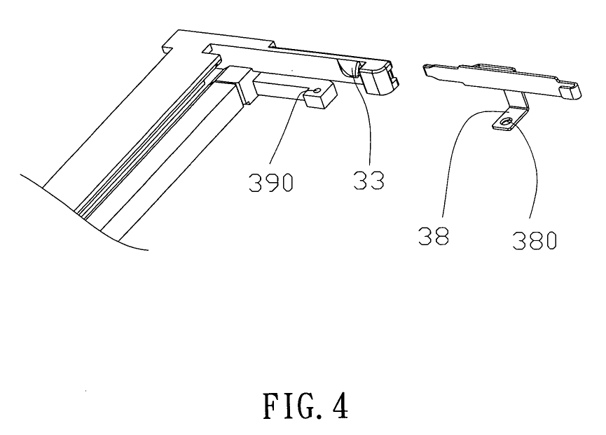

Please referring to FIGS. 1 to 4, the card edge connector of the present invention is illustrated. The card edge connector of the present invention serves to connect a memory module (not shown). The connector includes a long insulator body 1. A central slot 10 is formed at a longitudinal direction thereof. A plurality of conductive terminals 2 are installed at two sides of the central slot 10, which is electrically or mechanically connected to the memory module. A pair of locking devices 3 is installed at two opposite distal ends of the insulator body 1. Each locking device 3 includes a plastic unit 30 and a metal unit 31.

The plastic unit 30 extends from two ends of the insulating body 1. A front end thereof is installed with a retaining portion 33 which is protruded inwards for fixing the memory module. An outer side of the plastic unit 30 is a recess 36 for matching with the metal unit. The metal

The metal unit 31 is formed by bending the first arm 341 and the second arm 342 upwards by the first arm 341. The second arm 342 is installed on the lateral side of the first arm 341. A stop portion 35 is positioned at the second arm 342 for limiting over-movement of the first arm 341. Both of the metal units are placed on the opposite location with the same shape thereof. The distal end of the first arm 341 extends upwards and curves to be the buckling portion 40. The distal end of the buckling arm 32 of the plastic unit 30 has a buckling groove 401 for bucking the buckling portion 40. The first arm 341 is formed to be close to the outside of the buckling arm 32 and moves together with the buckling arm 32. The second arm 342 is formed by bending the extending first arm 341 upwards into two halves. The second arm 342 includes the connecting stop portion 35 and the connecting portion 343 of the first arm 341. The stop portion 35 is formed by bending the extending connecting portion 343 outwards. The distal end of the stop portion 35 extends downwards to be formed with a welding portion 38. The welding portion 38 is approximately vertical to the stop portion 35. The welding portion 38 has a via hole 380. The plastic unit 30 has a receiving hole 390 corresponding to the via hole 380. A welding material (not shown) is installed in the receiving hole 390 for welding the welding portion 38 and the circuit board to achieve the electrical connection of the card edge connector and the circuit board.

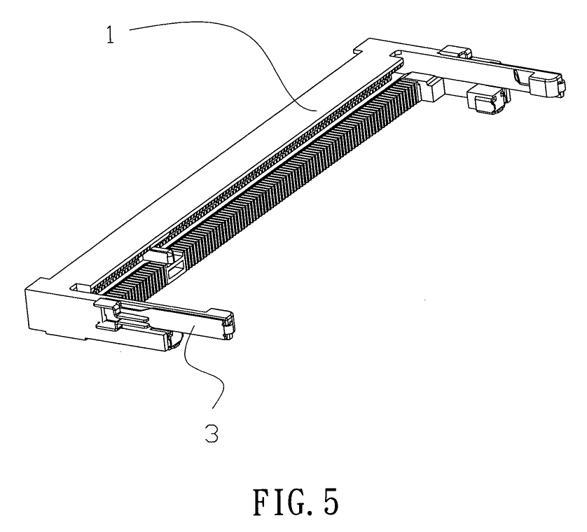

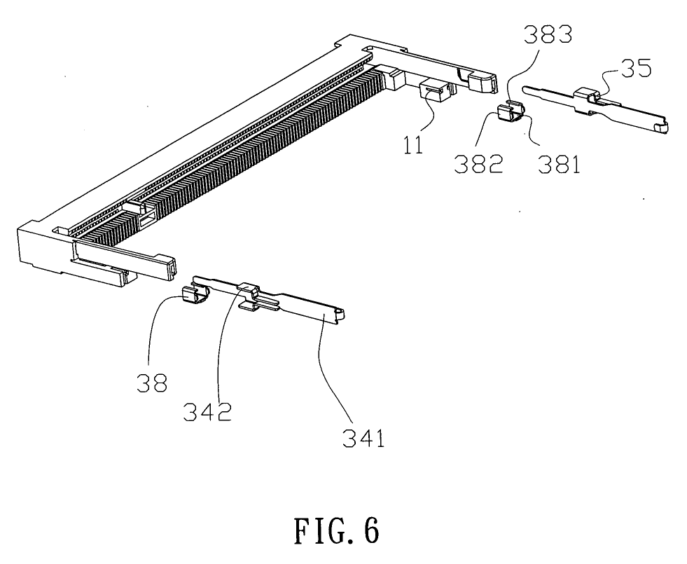

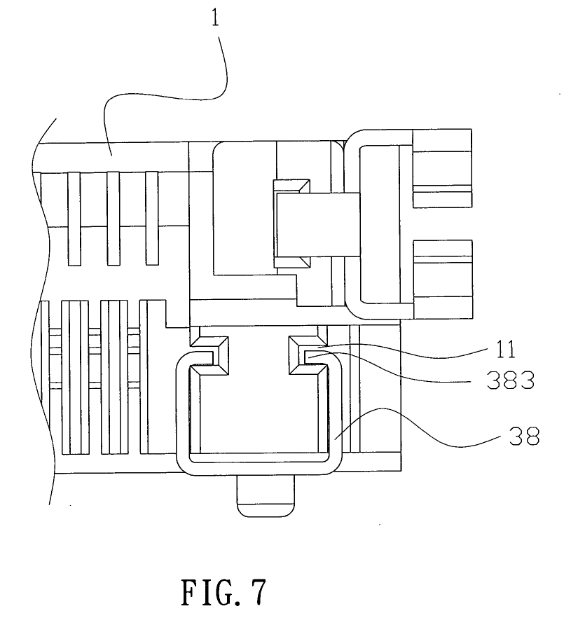

Referring to FIGS. 5 to 7, the second embodiment of the card edge connector of the present invention is illustrated, which is different from the above first embodiment. In the first embodiment, the second arm 342 is formed by bending at least one side of the extending first arm 341 upwards (in the second embodiment, the second arm 342 is formed by curving upwards two sides of the extending the first arm 341.) The two stop portions 35 are formed by symmetrically extending two sides of the second arm 342. Both of the stop portions 35 are exactly identical. Thereby it is not necessary to have any other extra module for the stop portion 35 and saves the production costs. The electrical connection has a welding unit 38 installed in the insulating body 1. The welding unit 38 includes a main body 381 and a fixed piece 382 formed by bending upwards two sides of the extending main body 381. The distal end of the fixed piece 382 has a buckling portion 383. The insulating body 1 has a buckling groove 11 corresponding toh the buckling portion 381. The buckling groove 11 is higher than the buckling portion 383. Besides, there is an interval between the welding portion 381 of welding unit 38 and the insulating body 1 so as to cause the welding unit 38 and insulating body 11 to move upwards and downwards. Then the welding material serves to weld the welding portion 38 and the circuit board.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A card edge connector comprising:
an insulating body having a central slot formed at a longitudinal direction thereof;
a pair of locking devices being installed at both opposite distal ends of the insulator body;
each locking device having a metal unit; and the mental unit having a first arm and a second arm formed by bending the first arm upwards; the second arm being placed at an outside of the first arm; and the second arm having a stop portion for limiting over movement of the first arm,
wherein each locking device further comprises a plastic unit, the plastic unit extending from two distal ends of the insulating body to form a plastic base with a buckling arm extending from the plastic base, each front distal end has a buckling arm, and the first arm extends along an outward facing surface of the buckling arm to engage a recess in the plastic base of the plastic unit,
wherein the locking device is configured to engage an outer surface of the plastic base.

2. The card edge connector as claimed in claim 1, wherein the second arm is formed by folding the extending first arm upwards into two halves.

3. The card edge connector as claimed in claim 1, wherein the second arm comprises a connecting stop portion and a connecting portion of the first arm; and the stop portion is formed by bending the extending connecting portion outwards.

4. The card edge connector as claimed in claim 1, wherein a distal end of the stop portion has a welding portion; and the welding portion is approximately vertical to the stop portion.

5. The card edge connector as claimed in claim 1, wherein the second arm is formed by bending curving at least one side of the first arm upwards.

6. The card edge connector as claimed in claim 5, wherein the second arm is formed by bending both opposite sides of the first arm upwards.

7. The card edge connector as claimed in claim 6, wherein the each stop portion is formed by extending symmetrically both sides of the second arm.

8. (canceled)

9. The card edge connector as claimed in claim 1, wherein the card edge connector comprises a welding unit; and the welding unit is installed on the insulating body.

10. The card edge connector as claimed in claim 9, wherein the welding unit and the insulating body are capable of moving upwards and downwards relatively.
